(19) United States
(12) Patent Application Publication
(10) Pub. No.: US 2021/0248616 A1
(43) Pub. Date: Aug. 12, 2021

(54) VALUE WARRANTY DATA VALIDATION AND ENCRYPTION SYSTEM

(71) Applicant: Verso, Inc., Dallas, `T (US)

(72) Inventor: Robert L. Foster, Dallas, TX (US)

(73) Assignee: Verso, Inc., Dallas, TX (US)

(21) Appl. No.: 17/172,451

(22) Filed: Feb. 10, 2021

Related U.S. Application Data
(60) Provisional application No. 62/972,740, filed on Feb. 11, 2020.

(51) Int. Cl. G06Q 30/00; H04L 9/32; H04L 9/08; H04L 29/06

(52) U.S. Cl. CPC G06Q 30/012; H04L 9/3236; H04L 2209/38; H04L 67/40; H04L 9/0869

(57) ABSTRACT

The present disclosure involves systems and methods for establishing an auditable and tamperproof record of warranty activities among parties to an associated digital warranty file. A blockchain or other distributed ledger may be used to encrypt, seal, and authenticate data associated with a warranty and stored with a warranty management system. Milestones and decisions associated with the digital warranty file may be encrypted and sealed on the blockchain to provide a fully auditable and non-repudiable record of the warranty process, thereby creating a trustworthy validation of warranty file activity as it moves through a warranty claim process. The blockchain based seals allow all participating parties to confidently rely on the information shared. Blockchain based seals of a warranty file or other data may assure the information cannot be tampered with, while reducing costs for researching and verifying each transaction.

### CROSS-REFERENCE TO RELATED APPLICATION

This application is related to and claims priority under 35 U.S.C. § 119(e) from U.S. Patent Application No. 62/972,740, filed Feb. 11, 2020 entitled “VALUE WARRANTY VALIDATION USING BLOCKCHAIN,” the entire contents of which is incorporated herein by reference for all purposes.

### TECHNICAL FIELD

Embodiments of the present invention generally relate to digital document management over a distributed ledger, and more specifically for management of warranty data and approvals of warranty activities among respective parties to a digital warranty file.

### BACKGROUND

The manufacture and selling of goods often involves warranties that protect parties within a supply chain that the sold goods are as advertised. Such warranties guarantee replacement of defective or under-performing goods and may be agreed upon between many parties to a transaction, such as dealers, suppliers, distributors, customers, and the like. In general, any party to a transaction may receive a warranty from other parties in the supply chain. In many instances, such warranties are contracts that set out terms of the warranty and may include signatures of the agreeing parties to execute the warranty. For example, a warranty may set out conditions resulting in a refund for a defective good, a replacement good, and/or labor and parts involved in replacing a defective good, among other warranty conditions.

While warranties provide reassurance to those purchasing goods, the management and processing of warranties may include significant cost and overhead. For example, modern warranties are typically digital files that include data and/or information corresponding to the terms of the warranty, identifying the parties associated with the warranty, and electronic signatures or approvals of said parties. Warranty management systems have been developed to create, store, manage, and otherwise process such digital warranties for any number and types of sold goods. Such warranty management systems provide some benefits when processing digital warranty files. For example, many warranties require purchasers to register their warranty with the warranty management system before the warranty takes effect. The registration process may include the purchaser filling out a registration form in some manner (such as through an online portal or other user interface) and submitting the form to a warranty managing system. The particulars of the warranty (such as term, price, conditions, etc.) may then be input into the warranty management system, either electronically or manually, via the same or a similar portal or interface. Claims and settlements controlled by a warranty and administered by the warranty management system may add additional processing time and effort. Further, each step in the creation and execution of a digital warranty file or other data structure may include mistakes, either intentional or unintentional, such that parties to the warranty may not be able to confidently rely on the warranty process. Rather, warranty information may be changed in the process such that parties to the warranty may mistrust the effectiveness of such warranties.

It is with these observations in mind, among others, that aspects of the present disclosure were conceived.

### SUMMARY

One aspect of the present disclosure relates to a method for managing a warranty agreement including the operations of receiving a digital warranty agreement file comprising data associated with one or more terms of a warranty agreement and salting and hashing the digital warranty agreement file to generate a hashed warranty agreement file. The method may also include the operations of transmitting the hashed warranty agreement file to a blockchain generating system, the blockchain generating system generating a warranty blockchain comprising a portion of the hashed warranty agreement file and storing, in a database, a link corresponding to a storage location of the warranty blockchain.

Some instances of the present disclosure may include receiving, via a user interface, a claim request associated with the digital warranty agreement file, salting and hashing an initial claim report corresponding to the claim request to generate a hashed initial claim report, and transmitting the hashed initial claim report to the blockchain generating system for inclusion in an updated warranty blockchain. The present disclosure may also include receiving, from the blockchain generating system, a second link corresponding to a second storage location of the updated warranty blockchain and transmitting, in response to receiving the second link and via the user interface, a storage location within the database of the second link.

In still other instances, the present disclosure may include receiving an identifier of a party to the digital warranty agreement file, the identifier indicating an approval of the party to the warranty agreement file, salting and hashing the identifier, and transmitting the hashed identifier to the blockchain generating system for inclusion in the warranty blockchain.

In still other instances, the present disclosure may include receiving, from the blockchain generating system, a validation report corresponding to the generation of the warranty blockchain comprising a portion of the hashed warranty agreement file and storing the validation report in the database.

Salting and hashing of the digital warranty agreement discussed herein may include, in some instances, inserting a unique string of values into the digital warranty agreement file and encrypting, based on a hash value, the digital warranty agreement file and the unique string of values.

Another aspect of the present disclosure includes one or more non-transitory tangible computer-readable storage media storing computer-executable instructions for performing the above processes on a computing system.

Still another aspect of the present disclosure relates to a warranty management system including a communication interface in communication with a distributed ledger generating system, one or more processors, and a non-transitory storage device configured to store one or more programs, wherein the one or more programs, when executed by the one or more processors, cause the one or more processors to perform operations. Such operations may include receiving, via a user interface, a digital warranty agreement file comprising one or more terms of a warranty agreement between parties to the warranty agreement, encrypting the digital warranty agreement file to generate an encrypted warranty agreement file, and transmitting, via the communication interface, the encrypted warranty agreement file and a unique identifier to the distributed ledger generating system, the distributed ledger generating system generating a digital warranty ledger comprising the encrypted warranty agreement file and the unique identifier. The operations may also include receiving an identifier of the digital warranty ledger, the identifier comprising a link to access the digital warranty ledger from the distributed ledger generating system

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1A is a diagram illustrating an example of a blockchain data structure which may be used in implementing embodiments of the present disclosure.

FIG. 1B is a system diagram illustrating a distributed ledger blockchain network which may be used in implementing embodiments of the present disclosure.

FIG. 1C is a system diagram illustrating a network of nodes which may be used in implementing embodiments of the present disclosure.

FIG. 2 is a diagram illustrating a workflow of a warranty validation system used in implementing embodiments of the present disclosure.

FIG. 3 is a flowchart of a method for validating and maintaining a warranty via a warranty validation system used in implementing embodiments of the present disclosure.

FIG. 4 is a flowchart of a method for processing and storing warranty claim information in a distributed ledger system used in implementing embodiments of the present disclosure.

FIG. 5 is a diagram illustrating an example of a computing system which may be used in implementing embodiments of the present disclosure.

### DETAILED DESCRIPTION

Aspects of the present disclosure involve systems, methods, and the like, for establishing an auditable and tamperproof record of warranty activities among the parties to an associated warranty file or other data structure. In one implementation, a blockchain or other distributed ledger may be used to encrypt, seal, and authenticate data associated with a warranty and stored at or otherwise associated with a warranty management system. Milestones and decisions associated with the digital warranty file may be encrypted and sealed on the blockchain to provide a fully auditable and non-repudiable record of the warranty process, thereby creating a trustworthy validation of warranty file activity as it moves through a warranty claim process. The blockchain based seals allow all participating parties to confidently rely on the information shared. Blockchain based seals of a warranty file or other data may assure the information cannot be tampered with, while reducing costs for researching and verifying each transaction. The blockchain warranty system may also reduce the administration costs of claim research, improve reporting accuracy, and accelerate settlement of warranty payments.

One particular implementation of a system for generating a record of warranty activities associated with a data representing a warranty agreement may include a warranty management system in communication with a blockchain generating system. The parties to a digital warranty file or data structure (also referred to herein as a “warranty agreement”) may be provided access to the warranty management system, such as via an API or user interface, to provide a warranty agreement, view and interact with a warranty agreement, alter portions of the warranty agreement, or otherwise manage the warranty agreement through a process of generation to settlement of claims under the agreement. The warranty agreement system may locally store the transactions associated with the warranty agreement in a database. Further, the warranty agreement system may provide information, reports, files, identifications, etc. of the warranty transactions to a distributed ledger system or blockchain generating system. The blockchain generating system may generate a warranty chain associated with the warranty agreement that is a fully auditable and non-repudiable record of the warranty transactions. The parties to the warranty agreement may then rely on the information included in the warranty chain as trustworthy, thereby preventing fraudulent activities associated with the warranty agreement. The warranty chain may include any types and numbers of warranty transactions associated with one or more digital warranty files or other data structures, including generation of the warranty agreement, approval signatures, claims made under the warranty, settlement agreements, payments to the parties, and the like to provide a trustworthy source of warranty information for the parties to the warranty management system. It should be appreciated that use of the term “warranty” or “warranty agreement” herein may refer to any data structure stored in and/or accessible from a computer-readable medium and from which information associated with a warranty may be obtained, processed, and/or altered.

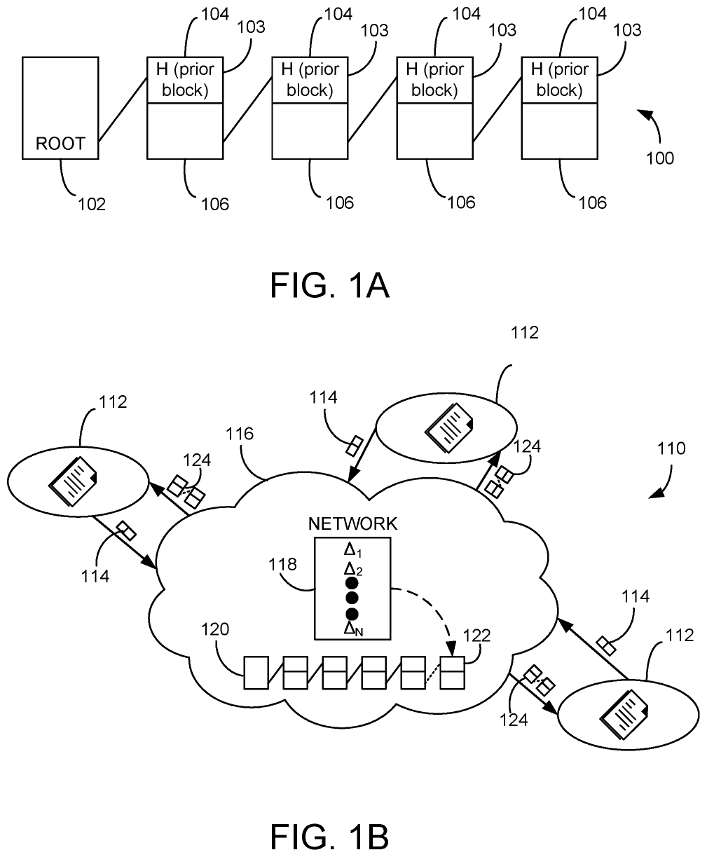

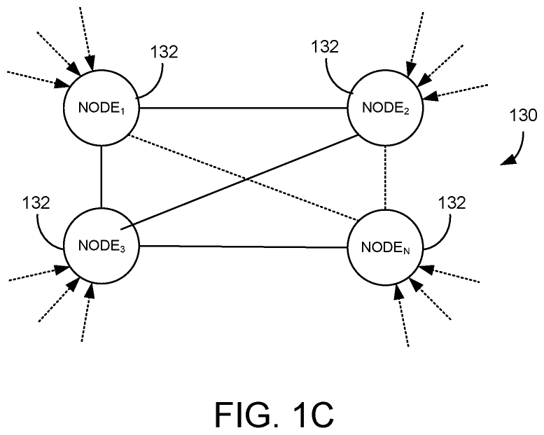

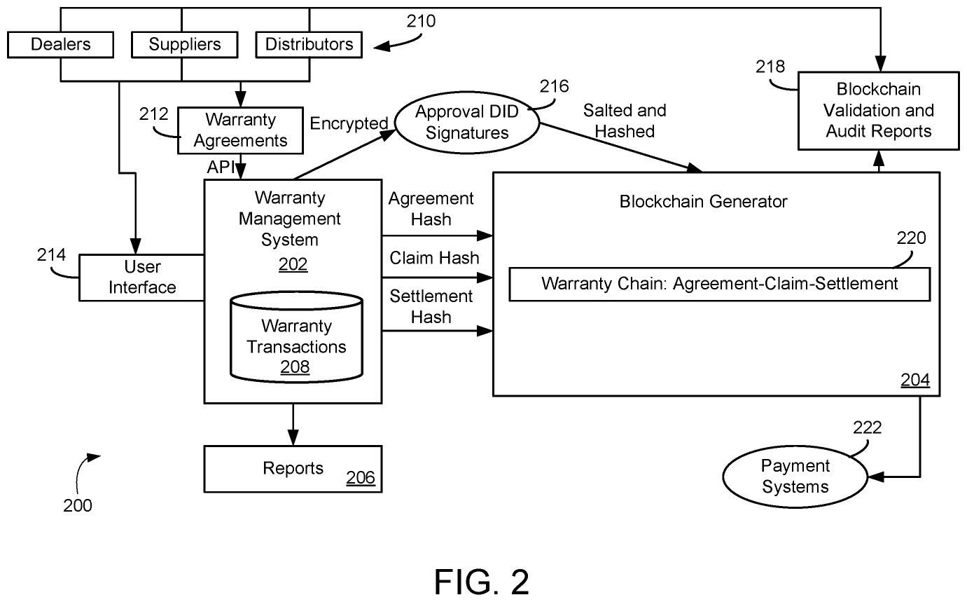

The disclosure now turns to discussion of figures and examples to further understanding of the systems and methods disclosed herein. Beginning in FIGS. 1A-C, examples of a distributed ledger (e.g., blockchain) network conforming to aspects of the present disclosure are shown. In particular, FIG. 1A is a diagram illustrating a blockchain data structure 100 made up of a sequence of linked blocks or nodes. A root block 102 can be generated to form a basis for the blockchain data structure 100 and can contain various descriptive data providing insight into an originating context or content of the blockchain data structure 100 such as timing information, design paradigms for later development along the blockchain, identification or organizational information, and the like. In some examples, the root block 102 may be an entry and/or node on another blockchain or distributed ledger system and, for example, form a sidechain or the like. The root block 102 can also include data or reference to items having relationships to be tracked by the blockchain data structure 100 such as, for example, portions of a warranty agreement between parties. Blocks 103 are cryptographically linked directly and indirectly to the root block 102 by a respective header 104 containing a hash of the preceding block 103 in the chain. For example, the block 103 following the root block 102 would include a hash of the root block in the header 104, while the next block in the chain would include a hash of the preceding block, and so on. Where the preceding block 103 is not the root block 102, the hash stored by the header 104 will include the hash stored by the header 104 and the contents 106 of the preceding block.

While cryptography is more widely known for obfuscating data, in the context of a blockchain, a cryptographic hash is used to validate the veracity of the contents of the previous block. Because a hash function will produce a virtually unique value for every given input, it is such that, so long as the hash header properly maps to the purported input (here, the preceding block) from which it was generated, that input is actually the input which originally generated it. In other words, the veracity of the hash is evidence that the preceding block and its contents have not been altered.

The contents 106 of the blocks 103 in the blockchain 100 may contain any type of data that may be represented as a byte stream. However, as depicted by FIG. 1B, a particular implementation may store one or more warranty packages 114, including but not limited to terms or other relevant data to the warranty, signatures of participants to the warranty, claim records, settlement information (such as cash transfer information) and the like, as the contents 106. For example, a network 116 may construct a new block 118 containing N, or an arbitrary number of, warranty packages 114. The document packages 114 typically represent a unique warranty 112, such as an updated document and may additionally include identifiers (e.g., document identifier hashes) for earlier document versions. Each unique warranty version 112 is recorded and transmitted as a document package 114 to the network 116 where, as depicted in FIG. 1C, one or more nodes 132 in a network 130 of nodes receive the record. The N nodes 132 can be fully connected—in other words, every node communicates with every other node—or can connect to an arbitrary and/or random number of other nodes so that all nodes communicate with many other nodes and thus all nodes directly or indirectly communicate with each other. In any case, all nodes 132 in the network 130 of nodes can receive updates to the blockchain 100 from the network. In some embodiments, each node 132 can further validate the veracity of an updated blockchain 120 before affirming receipt or broadcasting the updated blockchain 120 to the remainder of the network 130.

Using the nodes 132, the network 116 will generate a new block 118 containing each of the N warranty packages 114. For example, the new block 118 can then be appended onto a current blockchain 120 to create a most recent block 122, which includes the warranty packages 114 in the block contents 106 as well as an appropriate header 104 linking the most recent block 122 to preceding blocks of the blockchain 100. In some embodiments, the new block 118 is generated after a certain threshold number of warranty packages 114 are received. In other embodiments, after a certain amount of time, such as every 10 minutes, the network generates a new block 118 out of all warranty packages 114 that have been received since the last block was generated and stored in a pending cache or the like.

Referring now to FIG. 2, an example workflow 200 of a warranty validation system used in implementing embodiments of the present disclosure is provided. In general, the warranty validation system of the workflow 200 of FIG. 2 may include several components, devices, systems, and/or processes to establish an auditable and tamperproof record of aspects and alterations of a digital warranty file or warranty activities among the respective parties to the warranty agreement. More or fewer components may be included in the warranty management workflow 200 to manage one or more warranties utilizing a blockchain or other distributed ledger system. Further, more or fewer processes or steps may be included in the workflow 200 than are described, including sub-processes for the described steps.

As shown, the warranty validation workflow 200 may include a warranty management system 202. The warranty management system 202 may include a third party application or system (or an application or system of a party that not a signatory to a warranty agreement being managed by the system 202) utilized to manage the various processes associated with a warranty, such as execution, obtaining digital signatures, claims processing, payment processing, and the like. Initially, a warranty agreement 212 associated with a good may be provided to the warranty management system 202 by one or more parties 210 associated with the distribution of the good. For example, a dealer party, a supplier party, a distributor party, a customer, and the like associated with a transaction of a good may be provided access to the warranty management system 202 to interact with a warranty agreement 212 associated with the sold good. As noted above, the warranty 212 may be any type of data structure stored in and/or accessible from a computer-readable medium and from which information associated with a warranty may be obtained, processed, and/or altered. The warranty 212 may be provided by any party associated with the good being sold, but is typically provided by a manufacturer of the good. Regardless of the origination, the warranty 212 may be provided to the warranty management system 202 by uploading the warranty agreement file, such as via an Application Programming Interface (API) or other communication method between a computing system of the uploading party and the warranty management system 202. The warranty management system 202 may store the uploaded warranty agreements 212 in a warranty transactions 208 database or other non-transitory computer-readable medium associated with or in communication with the warranty management system 202. As discussed in more detail below, changes, updates, alterations, and other amendments to the warranty agreement 212 may be similarly stored in the warranty transactions database 208.

Upon uploading of the warranty agreement 212, the parties 210 to the warranty process may interact with the warranty file 212 via a user interface 214 associated with or in communication with the warranty management system 202. For example, each party 210 associated with the warranty agreement 212 may be provided with login or other identifying credentials to authenticate and authorize the corresponding party with the user interface 214. In one example, a party 210 may access the user interface via a browser of a computing device and provide the login information to the user interface. The user interface 214 may utilize the login information to identify the party providing the login credentials and grant access to one or more aspects of the warranty management system 202, such as providing access to one or more warranty files stored in the warranty transactions database 208.

Upon logging into the user interface 214 via the computing device associated with the party, one or more of the parties 210 may view the warranty agreement, electronically sign the warranty agreement 212, open a warranty claim process, enter relevant information concerning the good associated with the warranty 212, and the like. In general, any interaction with the warranty file 212 requested by the warranty management system 202 or desired by a party to the warranty may be provided to the warranty management system 202 via the user interface 214. Similarly, the warranty management system 202 may generate one or more reports, summaries, outlines, etc. 206 of a warranty agreement 212. These reports 206 may be viewed, downloaded, altered, or otherwise processed by a computing device of a party 210 via the user interface 214.

Previously, warranty management systems 202 managed the process flow for execution and processing of claims associated with a warranty. Although such systems 202 provide some security to the warranty agreement 212, such security results in a high manpower and processing cost for the parties involved. Further, bad actors within or external to the parties of the warranty may be provided access to the warranty via the user interface 214 (such as through stolen login information obtained by the bad actor) and attempt to falsify information, change previous alterations to the agreement, mistakenly or purposefully forge an electronic signature on the warranty, and the like to circumvent the security provided by the warranty management system 202. Thus, in one implementation, the warranty process flow 200 of FIG. 2 may utilize a blockchain or other distributed ledger system 204 to confidently and securely store changes, milestones, signatures, etc. associated with the warranty agreement 214. These blockchain based seals allow all participating parties 210 to confidently rely on the information shared. Blockchain based seals assure the information cannot be tampered while reducing the need to research and verify each transaction, improving reporting accuracy, and accelerating settlement of warranty payments.

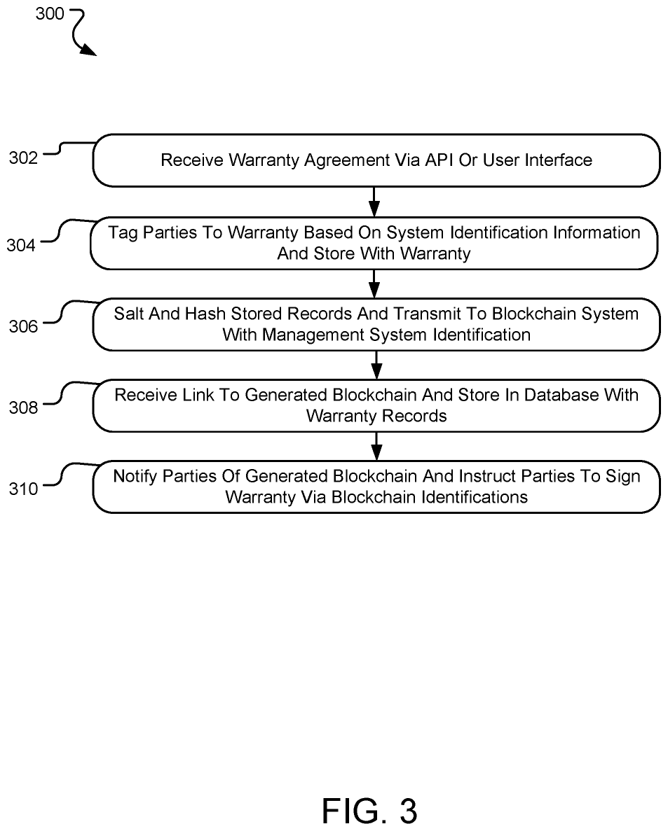

FIG. 3 is a flowchart of a method 300 for validating and maintaining a warranty via a warranty validation system used in implementing embodiments of the present disclosure. Although described below as being performed by the warranty management system 202, the operations of the method 300 of FIG. 3 may be performed, in some instances, by one or more components discussed above in relation to the warranty process flow 200. Such operations may be performed via execution of one or more programs, one or more hardware components of a system, or a combination of software and hardware components.

Beginning in operation 302, the warranty management system 202 may receive a warranty agreement 212 via the API, the user interface 214, or any other input system of the warranty management system 202. The warranty agreement 212 may be in the form of a transmittable document, file, data stream, program, and the like from any party 210 to the warranty agreement 212 or from a third party not a party to the agreement. In one example, the warranty agreement 212 electronically transmitted to the warranty management system 202 via the API configured to communicate with one or more systems to receive the agreement and translate portions of the agreement in accordance with an operating system of the warranty management system 202. In another example, the warranty agreement 212 may be uploaded by a party 210 to the warranty via the user interface 214. The user interface 214 may also employ the API to receive and translate the warranty agreement 212 as uploaded. Regardless of the source, the warranty agreement 212 may include any aspect of a warranty agreement, such as identifications of a product covered by the warranty, effective date of the agreement, terms of the warranty agreement (such as labor costs, part coverage, replacement part, conditions for making a claim, etc.), and the like. The warranty agreement 212 may be stored as a whole or portions of the warranty agreement may be stored individually in fields.

In operation 304, the warranty management system 202 may insert or otherwise associate one or more party tags with the received warranty agreement 212. The party tags may, in general, identify the parties 210 to the warranty agreement, such as distributors, customers, suppliers, dealers, etc. In one instance, each party 210 to the warranty may be registered with the warranty management system 202 and assigned or otherwise associated with identification information, such as a user name. The identification of the parties 210 may also be associated with a level of permission granted to that party. For example, the identifier of a party may be associated with a company such that the identification tag applied to the warranty agreement may be shared among many employees of the company based on a level of permission granted to those employees. In another example, each individual user of the warranty management system 202 may be provided a unique user name that may be associated with a warranty agreement 212 and provided a particular level of access to the warranty agreement 212. Upon tagging the warranty agreement 212 with the appropriate party identifiers, the warranty management system 202 may store the warranty agreement and party tags in the warranty transactions database 208.

Once stored, the warranty agreement 212 may encrypt the file via a salting and hashing algorithm executed by the warranty management system 202 in operation 306. In general, salting and hashing a digital file includes adding a unique value or string to the end of file (i.e., salting) before hashing the file via a known or hereafter developed hashing algorithm to obtain a unique hash value originating from the salted file. The hash value resulting from the salting and hashing algorithm represents the contents of the file while protecting access to the information of the file from unknown or malicious parties. The hashed value of the warranty agreement 212 after the hashing and salting operations may also be transmitted to the blockchain generator 204 in operation 306 for generation of a blockchain 220 of the warranty agreement, as described in more detail below. In some instances, identification information of the warranty management system 202 may also be transmitted with the hashed warranty agreement for inclusion in the warranty blockchain 220. For example, a file name, memory location in the warranty transaction database 208, or any other identifying information may be included with the hashed warranty agreement to identify the warranty file to the blockchain generator 204.

Upon receiving the hashed warranty agreement, the blockchain generator 204 may create a warranty chain 220 that includes the hashed agreement information and the identification information of the warranty management system 202. The warranty chain 220 may be generated as described above with relation to FIGS. 1A-1C. For example, a root block may be generated to forma basis for the blockchain data structure that contains data associated with the hashed warranty agreement. In some instances, the entirety of the warranty agreement may be stored within the blockchain data structure. In such an example, the root block for the chain may be generated to establish the blockchain, with connected blocks containing some portion of the hashed warranty agreement. In general, the blockchain may include any portion or all of the hashed warranty agreement, identifications of parties to the agreement, amendments or alterations to the agreement, or any other aspect or information related to or associated with the warranty agreement. Upon creation of the warranty chain 220 by the blockchain generator 204, a link to a hash of the blockchain, as well as the salt for the chain, may also be created and returned to the warranty management system 202 in operation 308. The warranty chain 220 link and salt may then be stored in the warranty transactions 208 database for use by the warranty management system 202.

In operation 310, the warranty management system 202 may notify the parties 210 to the warranty agreement 212 of the generated warranty chain 220. Such notification may occur via the user interface 214 or via other electronic communications, such as email, text, electronic voicemail, etc. The notification may, in some instances, include a request of the parties 210 to electronically sign the warranty agreement 212 via the user interface 214. In response to the notification, the parties 210 to the warranty agreement 212 may electronically sign the warranty agreement utilizing a digital identification (DID) 216 or any other digital mechanism for indicating an identification of a party. For example, one or more of the parties 210 to the warranty may access the warranty management system 202 and, via the user interface 214, apply a DID to a copy of the warranty agreement 212. Each DID 216 may be encrypted, salted, and/or hashed as described above and provided to the blockchain generator 204 for inclusion in the warranty chain 220. The DID 216 of each approving party 210 may also be stored in the warranty transactions database 208.

Through the method 300 of FIG. 3, a blockchain 220 associated with and storing information of a warranty agreement 212 may be generated. The blockchain generator 204 may provide one or more validation and/or audit reports 218 of the generated warranty chain 220 for analysis. For example, the warranty management system 202 may, in some instances, access the warranty validation and/or audit reports 218 to verify the generation of the warranty chain 220. Similarly, one or more parties 210 associated with the warranty agreement 212 may also access the validation and/or audit reports 218 to validate the generation of the warranty chain 220. Such reports 218 may also be stored in one or more storage media for use in analyzing historical information associated with the generated warranty chain 220.

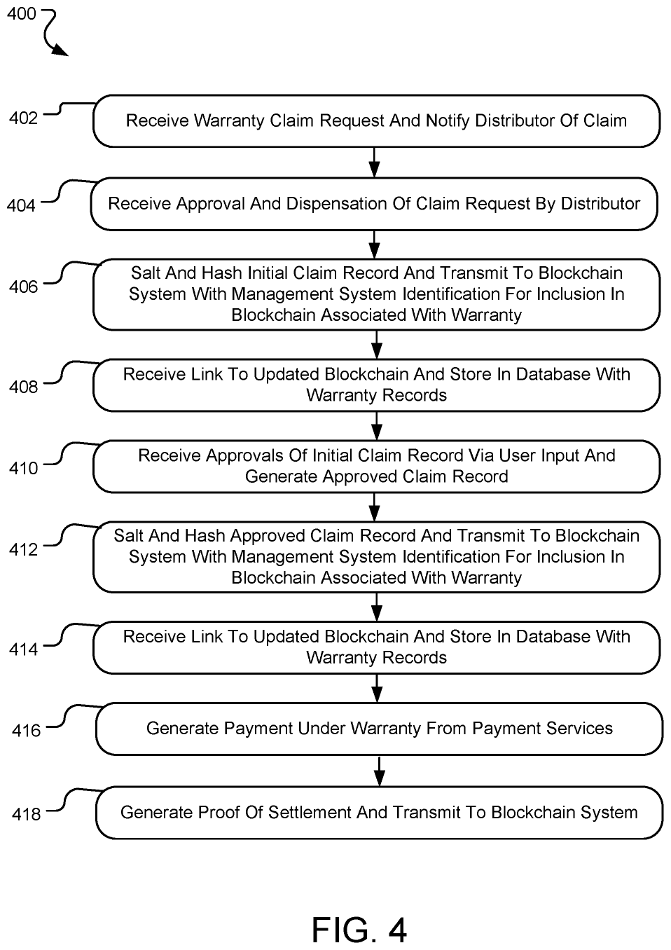

At some time, a claim under a warranty agreement 212 with a corresponding warranty chain 220 may be made by a party 210 to the warranty. For example, a particular part or component of a system covered by the scope of the warranty may become defective and one or more of the parties 210 to the warranty agreement 210 may make a claim for replacement of or reimbursement of payment for the defective part. FIG. 4 is a flowchart of a method 400 for processing and storing such warranty claim information in a distributed ledger system used in implementing embodiments of the present disclosure. Similar to above, the operations of the method 400 of FIG. 4 may be performed, in some instances, by one or more components discussed above in relation to the warranty process flow 200. Thus, although described below as being performed by the warranty management system 202, other components or systems may be included in performing the operations of the method 400. Further, such operations may be performed via execution of one or more programs, one or more hardware components of a system, or a combination of software and hardware components.

Beginning in operation 402, the warranty management system 202 may receive an initiated claim under a warranty agreement 212 managed by the warranty management system. In one example, a party 210 to the warranty agreement 212 may access the warranty management system 202 via the user interface 214, select the warranty agreement 212 at issue, and select to initiate a claim under the warranty agreement. The warranty management system 202 may request further information from the initiating party to further generate the warranty claim, such as an identification of requesting party, part or component information at issue, nature of the warranty claim (e.g., reimbursement of payment, replacement party, etc.). After the warranty claim information is provided, the warranty management system 202 may notify a responsible party for fulfilling the claim request of the initiated claim as indicated by the warranty agreement 212. For example, the warranty management system 202 may notify a distributor party of the claim request. In operation 404, the responsible party of the warranty agreement 212 may access the warranty management system 202 (such as via the user interface 214) and approve or deny the warranty claim. In some instances, the responsible party may also provide a dispensation amount based on the warranty claim. For example, the warranty agreement 212 may provide the responsible party with an option to reimbursement for various costs associated with a defective part, such as shipping costs, installation costs, damages, and the like. In such circumstances, the responsible party under the warranty agreement 212 may calculate a reimbursement amount to be provided in response to the warranty claim and provide the reimbursement or dispensation amount to the warranty management system 202. The approvals and information provided to the warranty management system 202 may also be stored in the warranty transaction database 214.

Upon approval by the parties 210 to the warranty agreement 212, the warranty management system 202 may, in operation 406, generate an initial claim record and salt and hash the initial claim record in a manner similar as described above. Also similar to above, the hashed initial claim record and utilized salt may be transmitted to the blockchain generator 204, along with an identifier of the warranty management system 202. In addition, the link to the generated warranty chain 220 may also be retrieved and provided by the warranty management system 202 to the blockchain generator 204 for identification and retrieval of the already generated warranty chain 220. The blockchain generator 204 may utilize the link to access the generated warranty chain 220 and attach the received information associated with the initial claim record to the warranty chain 220. For example, the blockchain generator 204 may generate a new link in the warranty chain 220 and store the hash of the initial claim record with the new link. The blockchain generator 204 may similarly include the hash and salt information associated with the initial claim record on the warranty chain 220.

Upon updating of the warranty chain 220, the blockchain generator 204 may transmit a link to the warranty management system 202 that links to the updated warranty chain 220, in operation 408. The warranty management system 202 may receive the link to the updated warranty chain 220 and store the link in the warranty transactions database 208. Other information associated with the updated warranty chain 220 may also be received and stored by the warranty management system 202. In operation 410, the warranty management system 202 may receive approvals of the initial claim record from one or parties 210 to the warranty agreement 212. In one example, the warranty management system 202 may notify the parties 210 to access the claim record via the user interface 214 of the warranty management system 202 and provide a DID signature via the user interface to indicate approval of the generated claim record. Further, the electronic signatures may include the unique identification information associated with the signing party 210 to ensure secure approvals of the claim record. Upon receiving approvals, the warranty management system 202 may generate an approved claim record in a similar manner as the generation of the initial claim record. The approved claim record may include the approval signatures provided by the parties 210 to the claim record.

In operation 412, the warranty management system 202 may salt and hash the approved claim record in a similar manner as described above and transmit the hashed record and/or the salt to the blockchain generator 204 for inclusion in the warranty chain 220. The approved claim record may, in some instances, be transmitted with the identification of the warranty management system 202 and/or the link to the warranty chain 220 such that the blockchain generator 204 may identify the warranty chain and verify the information received from the warranty management system 202. The blockchain generator 204 may, as described above, include the approved claim record in the warranty chain 220 and transmit a link to the updated warranty chain 220. The warranty management system 202 may, in operation 414, receive the link to the updated warranty chain 220 and store the link in the warranty transactions database 208 and associate the link with the warranty records for the warranty agreement 212 in the database. Other information concerning the approved claim record may also be stored in the database. For example, the hash of the initial claim record may be different than the hash of the warranty agreement 220 underlying the claim. The hashes may be stored together in the warranty chain 220, may be linked in the warranty transactions database 208, or the claim hash may include the link to the warranty agreement 212 hash. In these and other ways, the hashes for the claim record and the warranty agreement 212 may be linked or otherwise associated by the warranty management system 202.

In some instances, a negotiation of the details of the warranty claim may occur via the warranty management system 202. For example, upon generation of the initial claim record by the warranty management system 202, a party to the warranty agreement 212 may amend or alter the initial claim record with alternate terms. The warranty management system 202 may then notify the other parties to the claim record of the alteration to indicate approval of the amended claim record. The negotiation of claim terms under the warranty agreement 212 may continue between the parties. The warranty management system 202, in some instances, hash and store, in the warranty chain 220 associated with the warranty agreement 212, the multiple versions of the claim record that are offered by the parties 210 during the negotiations. The hashing and storing the warranty chain 220 may occur in a similar manner as described above. In this manner, the various activities and offers under the warranty agreement 212 may be stored in the chain 220 such that the parties may view the history of the negotiation and trust in the authenticity of the proposed claim terms.

Upon an agreed to claim under the warranty agreement 212, the warranty management system 202 may also facilitate payment corresponding to the approved claim. For example, the warranty management system 202 may verify the signatures of each party 210 to the warranty agreement 212 and the claim terms. In circumstances where the approved claim report includes a payment, the warranty management system 202 may generate a settlement report in operation 416. Similar to the other generated reports, the warranty management system 202 may salt and hash the settlement agreement and provide the agreement to the blockchain generator 204 for inclusion in the warranty chain 220. The generated settlement report may also be transmitted to one or more payment systems 222, either from the warranty management system 202 or the blockchain generator 204, to initiate payment under the claim terms to the parties 210 of the warranty agreement 212. In addition, the warranty management system 202 may also monitor activity on the warranty chain 220 to determine a status of the warranty agreement 212 and initiate payment of the settlement. For example, other systems, such as the payment systems, may provide information for inclusion in the warranty chain 220 in a similar manner as described above. As such, information may be added onto the warranty chain 220 that is not directly requested by the warranty management system 202. The payment systems 222 may provide the information and a payment system identifier for inclusion in the warranty chain 220. The warranty management system 202 may, in turn, monitor the warranty chain 220 for additions to the chain and access the information of the warranty chain 220. Upon verification of approval of payment to the parties 210, such as the inclusion of one or more DID signatures of the parties 210 in the warranty chain 220, the warranty management system 202 may command the payments system 222 to process the agreed upon payments.

In operation 418, the warranty management system 202 may receive verification from the payment systems 222 that payment to the parties 210 has been processed and occurred. In response, the warranty management system 202 may generate a final settlement report, salt and hash the final settlement report, and transmit the report to the blockchain generator 204 for inclusion in the warranty chain 220. The blockchain generator 220 may, as described above, include the final settlement report in the warranty chain 220.

Through the operations and systems described above, the transactions and occurrences associated with a warranty agreement 212 may be maintained in a distributed ledger (or blockchain). Including the warranty transaction information in the warranty chain 220 provides an auditable and tamperproof record of warranty activities among the parties to the warranty. The blockchain based seals of a warranty may assure the information cannot be tampered with, while reducing costs for researching and verifying each transaction. The blockchain warranty system may also reduce the administration costs of claim research, improve reporting accuracy, and accelerate settlement of warranty payments of the generation of a warranty agreement through a settlement agreement between the parties to the warranty.

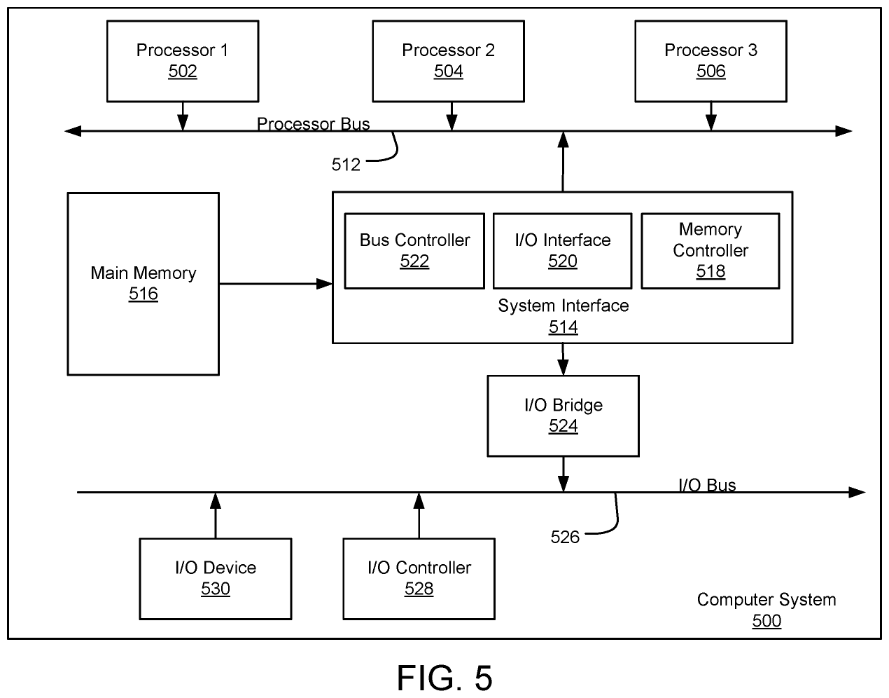

FIG. 5 is a block diagram illustrating an example of a computing device or computer system 500 which may be used in implementing the embodiments of the components of the network disclosed above. For example, the computing system 500 of FIG. 5 may be the warranty management system 202 discussed above. The computer system (system) includes one or more processors 502-506. Processors 502-506 may include one or more internal levels of cache (not shown) and a bus controller or bus interface unit to direct interaction with the processor bus 512. Processor bus 512, also known as the host bus or the front side bus, may be used to couple the processors 502-506 with the system interface 514. System interface 514 may be connected to the processor bus 512 to interface other components of the system 500 with the processor bus 512. For example, system interface 514 may include a memory controller 514 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system set forth in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A method for managing a warranty agreement, the method comprising:
receiving a digital warranty agreement file comprising data associated with one or more terms of a warranty agreement;
salting and hashing the digital warranty agreement file to generate a hashed warranty agreement file;
transmitting the hashed warranty agreement file to a blockchain generating system, the blockchain generating system generating a warranty blockchain comprising a portion of the hashed warranty agreement file; and
storing, in a database, a link corresponding to a storage location of the warranty blockchain.

2. The method of claim 1, further comprising:
receiving, via a user interface, a claim request associated with the digital warranty agreement file;
salting and hashing an initial claim report corresponding to the claim request to generate a hashed initial claim report; and
transmitting the hashed initial claim report to the blockchain generating system for inclusion in an updated warranty blockchain.

3. The method of claim 2, further comprising:
receiving, from the blockchain generating system, a second link corresponding to a second storage location of the updated warranty blockchain; and
transmitting, in response to receiving the second link and via the user interface, a storage location within the database of the second link.

4. The method of claim 1, further comprising:
receiving an identifier of a party to the digital warranty agreement file, the identifier indicating an approval of the party to the warranty agreement file;
salting and hashing the identifier; and
transmitting the hashed identifier to the blockchain generating system for inclusion in the warranty blockchain.

5. The method of claim 1, further comprising:
receiving, from the blockchain generating system, a validation report corresponding to the generation of the warranty blockchain comprising a portion of the hashed warranty agreement file; and
storing the validation report in the database.

6. The method of claim 1 wherein the digital warranty agreement file is received via an application programming interface (API).

7. The method of claim 1 wherein the salting and hashing of the digital warranty agreement file comprises:
inserting a unique string of values into the digital warranty agreement file; and
encrypting, based on a hash value, the digital warranty agreement file and the unique string of values.

8. A warranty management system comprising:
a communication interface in communication with a distributed ledger generating system;
one or more processors; and
a non-transitory storage device configured to store one or more programs, wherein the one or more programs, when executed by the one or more processors, cause the one or more processors to:
receive, via a user interface, a digital warranty agreement file comprising one or more terms of a warranty agreement between parties to the warranty agreement;
encrypt the digital warranty agreement file to generate an encrypted warranty agreement file;
transmit, via the communication interface, the encrypted warranty agreement file and a unique identifier to the distributed ledger generating system, the distributed ledger generating system generating a digital warranty ledger comprising the encrypted warranty agreement file and the unique identifier; and
receive an identifier of the digital warranty ledger, the identifier comprising a link to access the digital warranty ledger from the distributed ledger generating system.

9. The warranty management system of claim 8 wherein the one or more programs further cause the one or more processors to:
receive, via the user interface, a claim request associated with the digital warranty agreement file;
encrypt an initial claim report corresponding to the claim request to generate a hashed initial claim report; and
transmit the hashed initial claim report to the distributed ledger generating system for inclusion in an updated warranty ledger.

10. The warranty management system of claim 9 wherein the one or more programs further cause the one or more processors to:
receive, from the distributed ledger generating system, a second link corresponding to a second storage location of the updated warranty ledger; and
transmit, in response to receiving the second link and via the user interface, a storage location within a database.

11. The warranty management system of claim 8 wherein the one or more programs further cause the one or more processors to:
receive, via the user interface, an identifier of a party to the digital warranty agreement file, the identifier comprising a digital signature indicating an approval of the party to the warranty agreement file;
encrypt the identifier; and
transmit the encrypted identifier to the distributed ledger generating system for inclusion in the digital warranty ledger.

12. The warranty management system of claim 8 wherein the one or more programs further cause the one or more processors to:
receiving, from the distributed ledger generating system, a validation report corresponding to the generation of the digital warranty ledger comprising a portion of the encrypted warranty agreement file; and
storing the validation report in a database.

13. The warranty management system of claim 8 wherein encryption of the digital warranty agreement file comprises:
inserting a unique string of values into the digital warranty agreement file; and
encrypting, based on a unique hash value, the digital warranty agreement file and the unique string of values.

14. The warranty management system of claim 8 wherein the user interface executes an application programming interface (API) and the digital warranty agreement file is received via the API.

15. One or more non-transitory tangible computer-readable storage media storing computer-executable instructions for performing a process on a computing system, the process comprising:
receiving a digital warranty agreement file comprising data associated with one or more terms of a warranty agreement;
salting and hashing the digital warranty agreement file to generate a hashed warranty agreement file;
transmitting the hashed warranty agreement file to a blockchain generating system, the blockchain generating system generating a warranty blockchain comprising a portion of the hashed warranty agreement file; and
storing, in a database, a link corresponding to a storage location of the warranty blockchain.

16. The one or more non-transitory tangible computer-readable storage media of claim 15 wherein the process further comprises:
receiving, via a user interface, a claim request associated with the digital warranty agreement file;
salting and hashing an initial claim report corresponding to the claim request to generate a hashed initial claim report; and
transmitting the hashed initial claim report to the blockchain generating system for inclusion in an updated warranty blockchain.

17. The one or more non-transitory tangible computer-readable storage media of claim 16 wherein the process further comprises:
receiving, from the blockchain generating system, a second link corresponding to a second storage location of the updated warranty blockchain; and
transmitting, in response to receiving the second link and via the user interface, a storage location within the database of the second link.

18. The one or more non-transitory tangible computer-readable storage media of claim 15 wherein the process further comprises:
receiving an identifier of a party to the digital warranty agreement file, the identifier indicating an approval of the party to the warranty agreement file;
salting and hashing the identifier; and
transmitting the hashed identifier to the blockchain generating system for inclusion in the warranty blockchain.

19. The one or more non-transitory tangible computer-readable storage media of claim 15 wherein the process further comprises:
receiving, from the blockchain generating system, a validation report corresponding to the generation of the warranty blockchain comprising a portion of the hashed warranty agreement file; and
storing the validation report in the database.

20. The one or more non-transitory tangible computer-readable storage media of claim 15 wherein the process further comprises:
inserting a unique string of values into the digital warranty agreement file; and
encrypting, based on a hash value, the digital warranty agreement file and the unique string of values.
